(19) United States
(12) Patent Application Publication
(10) Pub. No.: US 2007/0261297 A1
(43) Pub. Date: Nov. 15, 2007

(54) Growth Limiter for Climbing Plants

(76) Inventor: Luc Gesche, Tubize (BE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/664,679

(22) PCT Filed: Oct. 11, 2005
(86) PCT No.: PCT/EP05/55170

§ 371 Date: Apr. 10, 2007

(30) Foreign Application Priority Data
Oct. 13, 2004 (BE) 2004/0501

(51) Int. Cl. A01G 7/04

(52) U.S. Cl. 47/1.3

(57) ABSTRACT

The present invention relates to a device (2) for limiting the undesirable development of climbing plants (7) on building walls (1), comprising a fence electrifier (5) and electric conductors (12).

### FIELD

The present invention relates to a device and a method for limiting climbing plant growth such as Virginia creeper or other plants that hang on a surface. The invention has a specific non-exclusive application in the field of horticulture.

### TECHNOLOGICAL BACKGROUND

Buildings for private or industrial use are often covered by climbing plants for an esthetical effect as well as for hiding buildings presenting no specific architectural interest. For rapidly covering any type of surface of the said buildings, Virginia creeper (Parthenocissusor Ampelopsis) is usually used. This vegetal cover has practically only advantages except one disadvantage: its overgrowing characteristic, so that it needs to be very frequently trimmed. It rapidly reaches cornices, drainpipes, tiles, windows, etc., possibly causing deteriorations and this restrains more than one to plant it.

### STATE OF THE ART

In order to limit climbing plant growth, a known practice is to manually cut shoots with pruning or gardening shears or scissors. As foliage is wished, most frequently, for covering the wall up to its higher portion but neither the roofing nor the vegetation drainpipe, ladders and scaffoldings are required. It goes without saying that the use of ladders or scaffoldings is dangerous and the method is slow and very costly.

### AIM OF THE INVENTION

The present invention aims to provide a device and a method for limiting the growth of climbing plants which would be easy as well as economical, in terms of use and installation, secure and not showing the disadvantages of the prior art.

### SUMMARY OF THE INVENTION

The present invention relates to a device for limiting climbing plant growth on a surface, which comprises a set of conducting elements electrically connected to a generator of voltage pulses and maintained on the said surface by an electrically insulating support.

In a preferred variation of the invention, the generator of voltage pulses is an electrifier for electric wire fences.

The conducting elements are preferably metal strips.

The electrically insulating supports are favorably sections having a slot able to receive a strip.

The present invention also relates to a set of elements selected among rectilinear elements, angular connectors and connectors for ridges, each element having a conducting strip and a section in an insulating material, the said strips being electrically connectable to each other, the said sections being able to be fixed on a surface, in order to make up a device for limiting climbing plant growth on a surface.

The present invention relates at last to a method for limiting climbing plant growth on a building wall, comprising the steps of:
arranging a set of rectilinear elements consisting each of a conducting strip and an insulating section on the said wall,
connecting the said rectilinear elements to each other, directly or by means of connectors,
applying electric voltage pulses to the said set.

In this process, an electrifier for wire fences is preferably used for generating the said electric pulses.

### BRIEF DESCRIPTION OF DRAWINGS

FIG. 1 is a front view of a building equipped with a growth limiter for climbing plant according to the invention.

FIG. 2 is an electrical circuit diagram of device 2 according to the invention.

FIG. 3 is a perspective view of a rectilinear element of a growth limiter for climbing plants according to the invention.

FIG. 4 is a top view of the rectilinear element of FIG. 3.

FIG. 5 is a top view of an angular connector of a growth limiter for climbing plants according to the invention.

FIG. 6 is a top view of a connecting element of a growth limiter for climbing plants according to the invention for wall ridge crossing.

FIG. 7 is a means for connecting electrically two elements or connectors of a device of the invention.

### DETAILED DESCRIPTION OF A PREFERRED EMBODIMENT OF THE INVENTION

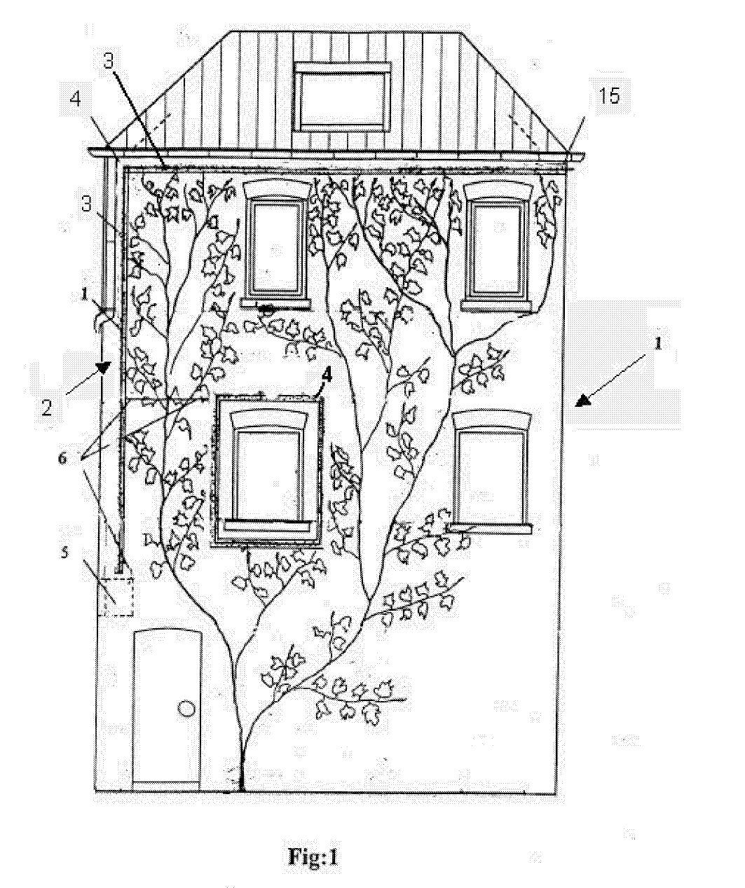

FIG. 1 is an example of a building 1 equipped with a growth limiter 2 for climbing plants according to the invention. This device 2 consists of a set of rectilinear elements 3 and of angular connectors 4, fixed on a wall of building 1, and connected to an electrifier 5. An electrically insulated connector 6 connects a set of elements (1, 4) surrounding a window to the other elements 1 of device 2. Element 15 is an angular connector enabling to cross a ridge of building 1.

FIG. 2 is an electrical circuit diagram of device 2 according to the invention. Electrifier 5 is a voltage pulse generator. The devices for electric fences, used for breeding, are suitable for use in the context of the invention. A device generating pulses of 10 000 V, having an energy of 100 mJ, and repeated every 5 seconds is efficient for limiting Parthenocissus' growth. Electrifier 5 is connected on the one hand to the earth, and on the other hand to the exposed conductors 12 of elements 1, 4 of device 2. It is important that the set of exposed conductors 12 of elements 1 and connectors 4, 15 are electrically in contact with electrifier 5. A climbing plant 7 could grow freely, up to reaching an element 1 at contact point 8. The electrical pulses given by electrifier 5 will find a way back to the earth through the stem and roots of plant 7 or through the wall of building 1, and, in doing so, causing the drying out and the destruction of the young shoot at the end of the stem. At the opposite of the traditional method of limiting climbing plant growth, no cutting scrap is produced. In order to improve the building wall ground earthing, non-insulated conductors 9 could be fixed on the wall and earthed.

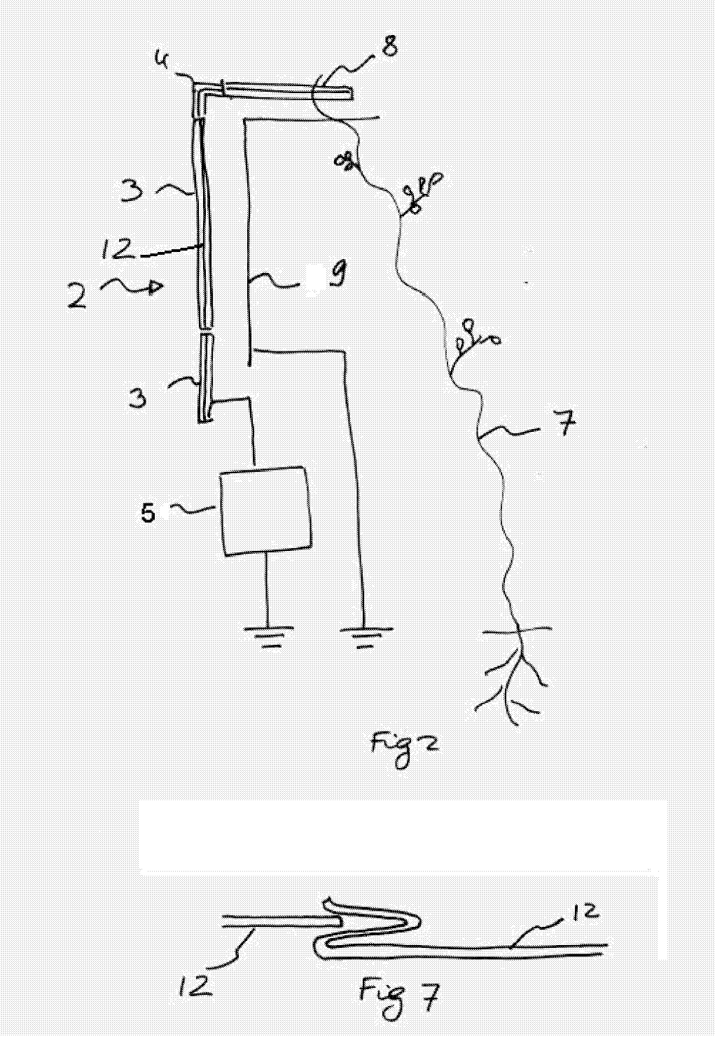

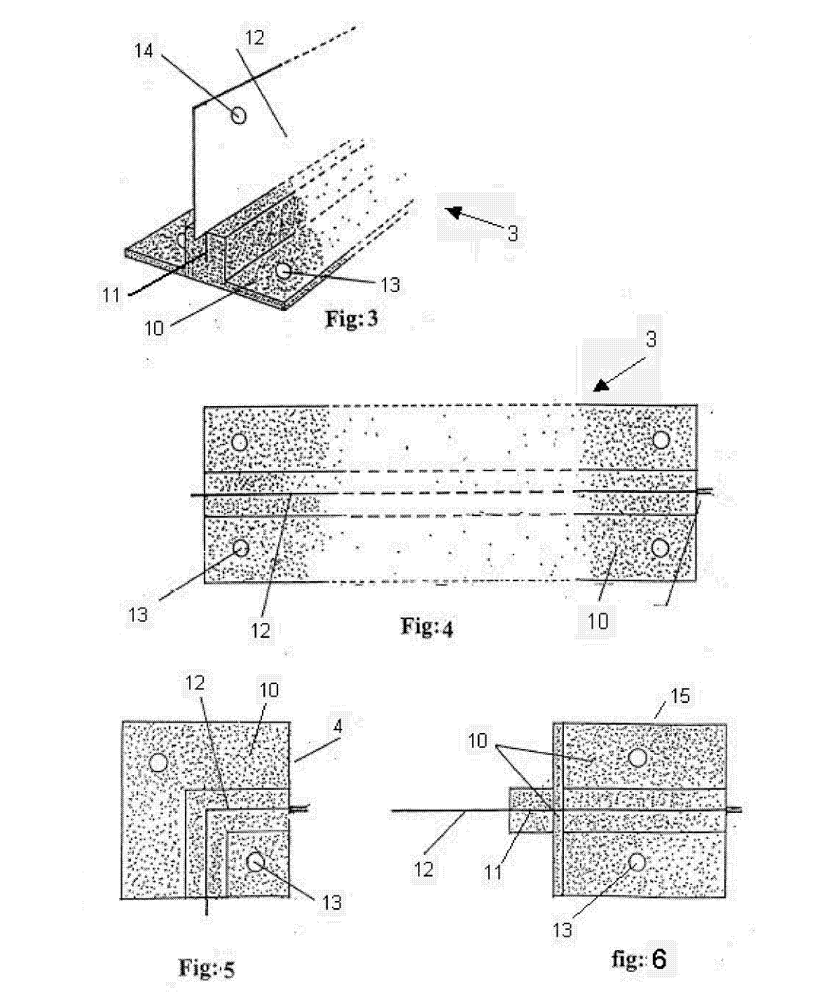

FIG. 3 is a rectilinear element 3 of a device 2 according to the invention. A section 10 made of PVC, or in another insulating material, shows a flat surface to be fixed on a wall, and a slot 11 for receiving a metal strip 12. Metal strip 12, preferably in stainless steel, could however be made of any other conducting material that is corrosion resistant, as e.g. a polymeric material, filled with a conducting component such as carbon fiber. In a variation of the invention, the insulating section 10 and the conducting strip 12 are obtained by a unique molding, a part only of the said molding being filled with conducting fibers. This solution presents the advantage of simplicity for manufacturing and for assembly. Strip 12 can present holes 14 whereby electric continuity of device 2 can be obtained, by bolting electric wires. FIG. 4 is a top view of the same rectilinear element 3 in which holes 13 for fixing to a wall are shown. These elements could be of arbitrary length; this is shown by the broken line of FIG. 3; they could be cut to the required length or provided in a set of prefixed lengths.

FIG. 5 shows an angular connector 4 for a device 2 of the invention. This angular connector 4 comprises a metal strip 12 folded up in an angle, on a section 10 with an adapted shape and enables assembling a device 2 according to a wished path. Another type of connection, ridge crossing connector 15, as shown on FIG. 6, enables connecting rectilinear elements 3 placed on various walls of the building. This connector 15 comprises a conducting <<L>>-shaped strip 12. A device 2 adapted to any building shape can be made up from a set having rectilinear elements 3, of different lengths, angular connectors 4, various angles, e.g. 90° and 135°, and ridge crossing connectors 15. Rectilinear elements 3 can also be sawed to length according to the needs of building 1. Once the set of elements 3 and of connectors 4, 15 are well fixed on a building wall, e.g. with insulating-head screws for avoiding risks of electric arcs and losses, the set is connected to a fence electrifier 5 by one of the holes 14 in the closest strip 12. Of course, electrifier 5 could be connected only during the growth period of the plants.

FIG. 7 shows a means for an electric connection of two elements 1 or connectors 4,15 of a device 2 of the invention, wherein a strip end 12 is folded up with a <21 Z>>-shape, thereby forming a small recess wherein a flat end of another strip 12 could be clipped.

By combining elements from a set of rectilinear elements 3, of different lengths, of angular connectors 4, of various angles, e.g. 90° and 135°, and of ridge crossing connectors 15, it is possible to make up a device 2 adapted to any building shape. Sections 10 can be made in a color close to the material of the building wall. Strips 12 having a width of 5 cm gave good results in limiting climbing plant growth, without being too visible and without offering a bird roost. For irregular media, such as old stone walls, it should be made sure that silicon is used under insulated sections, in order to mold medium imperfections and prevent that the plant edges its way under the section.

1. Device (2) for limiting climbing plant growth on a surface, comprising a set of conducting elements (12) electrically connected to a voltage pulse generator (5) and maintained on the said surface by an electrically insulating support (10).

2. Device (2) according to claim 1, wherein the voltage pulse generator (5) is an electrifier (5) for electric fences.

3. Device according to claim 1, wherein the said conducting elements are metal strips (12).

4. Device according to claim 1, wherein the said electrically insulating supports are sections (10) having a slot (11) adapted to receive a strip (12).

5. Device according to claim 1, wherein the said conducting elements (12) and electrically insulating supports (10) are obtained in molding a polymer in which a part (12) is filled with conducting fibers.

6. Set of elements chosen among rectilinear elements (3), angular connectors (4) and ridge crossing connectors (15), each having a conducting strip (12) and a section (10) in an insulating material, the said strips (10) being electrically connectable to each other, the said sections (10) being able to be fixed on a surface, in order to make up a device according to any of the preceding claims.

7. Method for limiting the growth of climbing plants (7) on a building wall (1) comprising the steps of:
arranging a set of rectilinear elements (3) comprising each a conducting strip (12) and an insulating section (10) on the said building wall,
connecting the said rectilinear elements to each other, directly or by means of connectors (4,15),
applying voltage pulses to the said set.

8. Process according to claim 7, wherein an electrifier (5) for electric fences is used in order to generate the said voltage pulses.
